(19) United States
(12) Patent Application Publication
(10) Pub. No.: US 2012/0169666 A1
(43) Pub. Date: Jul. 5, 2012

(54) OPTICAL TOUCH-SENSING LIQUID CRYSTAL PANEL, OPTICAL TOUCH-SENSING PANEL AND METHOD OF DETERMINING TOUCH POSITION

(75) Inventors: Fu-Cheng Fan, Taoyuan County (TW); Hsing-Jung Chuang, Chiayi County (TW); Yu-Ping Wu, Hsinchu County (TW); Tzu-Ling Niu, Kaohsiung City (TW)

(73) Assignee: AU OPTRONICS CORPORATION, Hsinchu (TW)

(21) Appl. No.: 13/071,482

(22) Filed: Mar. 24, 2011

(30) Foreign Application Priority Data
Dec. 31, 2010 (TW) 99147324

(51) Int. Cl. G06F 3/042

(52) U.S. Cl. 345/175

(57) ABSTRACT

An optical touch-sensing liquid crystal panel including a backlight, a liquid crystal display panel, a first reflector, a second reflector and a plurality of photo sensors is provided. The liquid crystal display panel includes a pixel array and a plurality of output light-valves, wherein the output light-valves are located outside the pixel array. The first reflector is disposed above the output light-valves. The photo sensors are disposed under the second reflector. The output light-valves and the photo sensors are respectively turned on by turns. When each of the output light-valves is turned on, the invisible light provided by the backlight passes through the output light-valves, the invisible light is then reflected by the first reflector as well as the second reflector in sequence and is captured by the corresponding photo sensor.

### CROSS-REFERENCE TO RELATED APPLICATION

This application claims the priority benefit of Taiwan application serial no. 99147324, filed Dec. 31, 2010. The entirety of the above-mentioned patent application is hereby incorporated by reference herein and made a part of this specification.

### BACKGROUND OF THE INVENTION

1. Field of the Invention

The present invention relates to a touch-sensing panel and a touch-sensing method thereof, and more particularly to an optical touch-sensing liquid crystal display (LCD) panel, an optical touch-sensing panel and a method of determining touch position.

2. Description of Related Art

Currently, information technology, wireless mobile communication and information appliances have been rapidly developed and applied, to achieve more convenience, touch-sensing panels are gradually used in information products and conventional input devices such as key boards or mice are substituted thereby. Generally, touch-sensing panels can be categorized into resistance touch-sensing panels, capacitance touch-sensing panels, acoustic wave touch-sensing panels, optical touch-sensing panels, electromagnetic touch-sensing panels and so on. The capacitance touch-sensing panels and the optical touch-sensing panels are more popular in the market.

FIG. 1 schematically illustrates a top view of a conventional optical touch-sensing panel. Referring to FIG. 1, the conventional optical touch-sensing panel 100 has a touch-sensing region 110 and includes sensing light sources 120a and 120b as well as photo-sensors 130a and 130b. The sensing light sources 120a and 120b are disposed corresponding to the photo-sensors 130a and 130b. A plurality of infrared light-emitting diodes (IR-LEDs) with high collimation are used as the sensing light sources 120a and 120b and the IR-LEDs emit an IR light L1. The IR light L1 emitted from each of the sensing light sources 120a and 120b are received by the photo-sensors 130a and 130b, respectively. When the touch-sensing panel 110 is touched by an object 140, a part of the IR light L1 is shielded by the object 140. Since the part of the IR light L1 is shield and not transmitted to the corresponding photo-sensors (e.g. the photo-sensors 130a1, 130a2, 130b1 or 130b2 shown in FIG. 1), touch position can be determined by the circuit electrically connected to the photo-sensors 130a and 130b. In the conventional optical touch-sensing panel 100, since the IR light L1 emitted from each of the sensing light sources 120a and 120b is required to have high collimation, collimation lenses are needed to prevent divergence of the IR light L1.

However, base on the method of determining touch position mentioned above, the touch-sensing definition of the optical touch-sensing panel 100 is relevant to and determined by the quantity of the sensing light sources 120a and 120b. When the above-mentioned optical touch-sensing panel 100 is applied to the large-scale display panels, in order to obtain an acceptable touch-sensing definition, it is difficult to effectively reduce the quantity of the sensing light sources 120a and 120b and the photo-sensors 130a and 130b used. Accordingly, fabrication costs of the conventional optical touch-sensing panel 100 can not be reduced further. How to reduce fabrication costs of the optical touch-sensing panels without lowering touch-sensing definition thereof is an important issue.

### SUMMARY OF THE INVENTION

The present invention provides an optical touch-sensing LCD panel and an optical touch-sensing panel having favorable touch-sensing definition and reduced fabrication costs.

The present invention further provides a method of determining a touch position, wherein the photo-sensors and the sensing light sources are not required to be adopted one-on-one.

The present invention provides an optical touch-sensing LCD panel. The optical touch-sensing LCD panel includes a backlight, a liquid crystal display panel, a first reflector, a second reflector and a plurality of photo-sensors. The backlight is capable of providing a visible light and an invisible light. The LCD panel is disposed above the backlight, wherein the LCD panel includes a pixel array and a plurality of output light-valves, wherein the output light-valves are located outside the pixel array. The first reflector is disposed above the output light-valves. The photo-sensors are disposed under the second reflector, wherein the output light-valves and the photo-sensors are respectively turned on by turns; when each of the output light-valves is turned on, the invisible light provided by the backlight passes through the output light-valves, the invisible light passing through the output light-valves is reflected by the first reflector as well as the second reflector in sequence and is captured by the corresponding photo-sensors.

The present invention further provides an optical touch-sensing panel. The optical touch-sensing panel includes a touch panel, a light source, a first reflector, a second reflector and a plurality of photo-sensors. The touch panel includes a touch-sensing region and a plurality of output light-valves located outside the touch-sensing region. The light source is disposed under the output light-valves and provides an invisible light. The first reflector is disposed above the output light-valves. The photo-sensors are disposed under the second reflector, wherein the output light-valves and the photo-sensors are respectively turned on by turns; when each of the output light-valves is turned on, the invisible light provided by the backlight passes through the output light-valves, the invisible light passing through the output light-valves is reflected by the first reflector as well as the second reflector in sequence and is captured by the corresponding photo-sensors.

In an embodiment of the present invention, the above-mentioned optical touch-sensing LCD panel further includes a plurality of receiving light-valves located outside the pixel array. The output light-valves and the receiving light-valves are disposed at opposite sides of the pixel array respectively. The second reflector is disposed above the receiving light-valves, and each of the photo-sensors is disposed under one of the receiving light-valves respectively, wherein the output light-valves and the receiving light-valves are respectively turned on by turns. Each of the output light-valves and one of the receiving light-valves corresponding thereto are turned on and turned off simultaneously. When each of the output light-valves and one of the receiving light-valves corresponding thereto are turned on, the invisible light provided by the backlight passes through the output light-valves, the invisible light passing through the output light-valves is reflected by the first reflector as well as the second reflector in sequence and passes through the receiving light-valves, and the invisible light passing through the receiving light-valves is captured by the corresponding photo-sensors.

In an embodiment of the present invention, the above-mentioned optical touch-sensing panel further includes a plurality of receiving light-valves located outside the touch-sensing region. The output light-valves and the receiving light-valves are disposed at opposite sides of the touch-sensing region respectively. The second reflector is disposed above the receiving light-valves, and each of the photo-sensors is disposed under one of the receiving light-valves respectively, wherein the output light-valves and the receiving light-valves are respectively turned on by turns. Each of the output light-valves and one of the receiving light-valves corresponding thereto are turned on and turned off simultaneously. When each of the output light-valves and one of the receiving light-valves corresponding thereto are turned on, the invisible light provided by the backlight passes through the output light-valves, the invisible light passing through the output light-valves is reflected by the first reflector as well as the second reflector in sequence and passes through the receiving light-valves, and the invisible light passing through the receiving light-valves is captured by the corresponding photo-sensors.

In an embodiment of the present invention, the output light-valves includes a plurality of first output light-valves arranged along a column direction and a plurality of second output light-valves arranged along a row direction, while the receiving light-valves includes a plurality of first receiving light-valves arranged along the column direction and a plurality of second receiving light-valves arranged along the row direction. Specifically, the output light-valves and the first receiving light-valves are respectively turned on by turns. Each of the output light-valves and one of the first receiving light-valves corresponding thereto are turned on and turned off simultaneously. In addition, the second output light-valves and the receiving light-valves are respectively turned on by turns. Each of the second output light-valves and one of the receiving light-valves corresponding thereto are turned on and turned off simultaneously.

The invention further provides a method of determining a touch position, the method comprises the following steps. First, a optical touch-sensing panel including a touch panel, a light source, a first reflector, a second reflector and a plurality of photo-sensors is provided, wherein the touch panel includes a touch-sensing region, a plurality of output light-valves located outside the touch-sensing region and a plurality of receiving light-valves located outside the touch-sensing region, the output light-valves and the receiving light-valves are disposed at opposite sides of the touch-sensing region respectively, the light source is disposed under the output light-valves and provides an invisible light, the first reflector is disposed above the output light-valves, the second reflector is disposed above the receiving light-valves, and each of the photo-sensors is disposed under one of the receiving light-valves. Then, the output light-valves and the receiving light-valves are respectively turned on by turns, wherein each of the output light-valves and one of the receiving light-valves corresponding thereto are turned on and turned off simultaneously, when each of the output light-valves and one of the receiving light-valves corresponding thereto are turned on, the invisible light provided by the backlight passes through the output light-valves, the invisible light passing through the output light-valves is reflected by the first reflector as well as the second reflector in sequence and passes through the receiving light-valves, and the invisible light passing through the receiving light-valves is captured by the corresponding photo-sensors.

As mentioned above, the optical touch-sensing LCD panel and the optical touch-sensing panel determines the touch position by controlling the time points that the output light-valves and the receiving light-valves are turned on or turned off. In other words, the touch-sensing definitions of the optical touch-sensing LCD panel and the optical touch-sensing panel are not limited by the quantity of the sensing light sources. Accordingly, the present invention can reduce fabrication costs of the optical touch-sensing LCD panel and the quantity of the sensing light sources without lowering touch-sensing definition thereof.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 schematically illustrates a top view of a conventional optical touch-sensing panel.

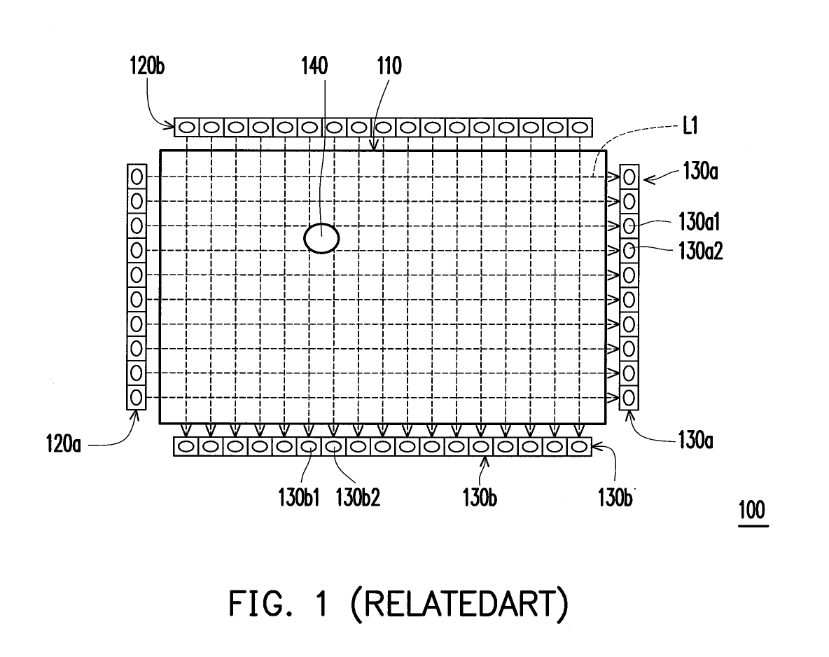

FIG. 2A schematically illustrates a top view of an optical touch-sensing LCD panel in accordance with the first embodiment of the present invention.

FIG. 2B schematically illustrates a cross-sectional view of the optical touch-sensing LCD panel shown in FIG. 2A.

FIG. 3 schematically illustrates a top view of another optical touch-sensing LCD panel in accordance with the first embodiment of the present invention.

FIG. 4 schematically illustrates a cross-sectional view of the optical touch-sensing LCD panel shown in FIG. 3.

FIG. 5A schematically illustrates a top view of an optical touch-sensing panel in accordance with the second embodiment of the present invention.

FIG. 5B schematically illustrates a cross-sectional view of an optical touch-sensing panel in accordance with the second embodiment of the present invention.

FIG. 6 is a flow chart illustrating a method of determining the touch position according to an embodiment of the present invention.

### DESCRIPTION OF EMBODIMENTS

### First Embodiment

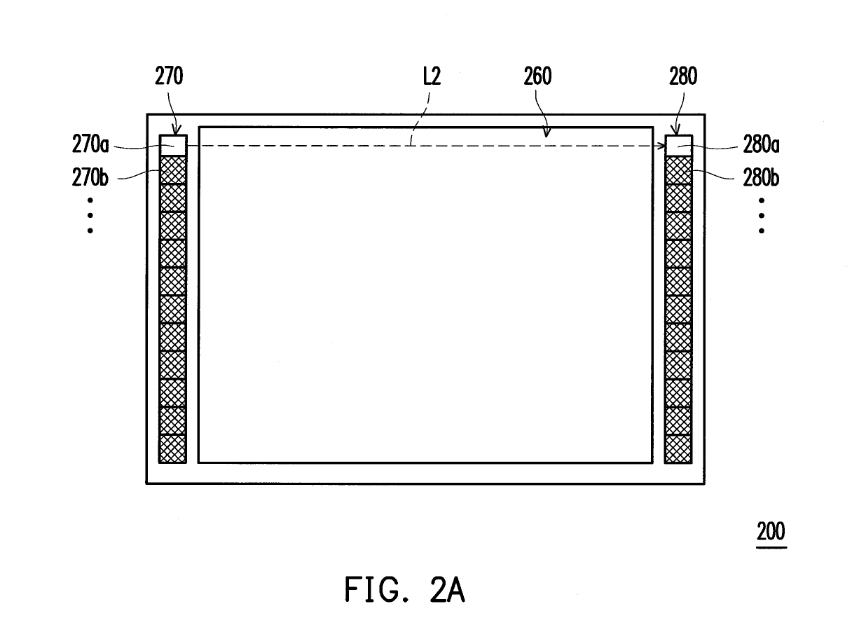

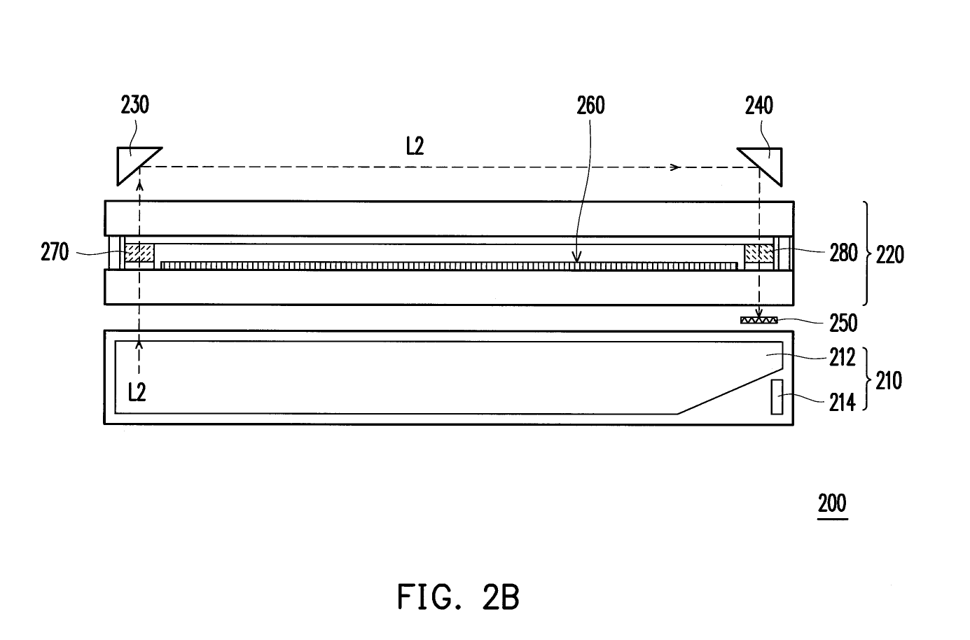

FIG. 2A and FIG. 2B are schematic views of an optical touch-sensing LCD panel in accordance with the first embodiment of the present invention, wherein FIG. 2A and FIG. 2B respectively illustrate a top view and a cross-sectional view of the optical touch-sensing LCD panel. Referring to FIG. 2A and FIG. 2B, the optical touch-sensing LCD panel 200 includes a backlight 210, a LCD panel 220, a first reflector 230, a second reflector 240 and a plurality of photo-sensors 250. The backlight 210 is capable of providing a visible light and an invisible light L2. The LCD panel 220 is disposed above the backlight 210, wherein the LCD panel 220 includes a pixel array 260 and a plurality of output light-valves 270 located outside the pixel array 260. The first reflector 230 is disposed above the output light-valves 270. The photo-sensors 250 are disposed under the second reflector 240, wherein the output light-valves 270 and the photo-sensors 250 are respectively turned on by turns. When each of the output light-valves 270 is turned on, the invisible light L2 provided by the backlight 210 passes through the output light-valves 270, the invisible light L2 passing through the output light-valves 270 is reflected by the first reflector 230 as well as the second reflector 240 in sequence and is captured by the corresponding photo-sensors 250.

In an alternative embodiment, in addition to the pixel array 260 and the output light-valves 270 located outside the pixel array 260, the LCD panel 220 disposed above the backlight 210 may further include a plurality of receiving light-valves 280 located outside the pixel array 260. The receiving light-valves 280 and the output light-valves 270 are respectively arranged at two opposite sides of the pixel array 260. Moreover, the first reflector 230 is disposed above the output light-valves 270, while the second reflector 240 is disposed above the receiving light-valves 280. In order to clearly describe the output light-valves 270 and the receiving light-valves 280, the illustrations of the first reflector 230 and the second reflector 240 are omitted in FIG. 2A.

Referring to FIG. 2A and FIG. 2B, each of the photo-sensors 250 are disposed under the receiving light-valves 280. For example, the photo-sensors 250 are provided by a Charge Coupled Device (CCD), a Complementary Metal-Oxide-Semiconductor (CMOS) chip. As shown in FIG. 2B, the photo-sensors 250 of the present embodiment may be mounted on a printed circuit board and be disposed under the LCD panel 220. In other words, the photo-sensors 250 of the present embodiment are not built in the LCD panel 220.

The backlight 210 simultaneously provides a visible light for image display and an invisible light L2 for touch-sensing. For example, the visible light is white light, the invisible light L2 is IR light, and the photo-sensors 250 is an IR sensor capable of detecting IR light.

It is noted that the output light-valves 270 and the receiving light-valves 280 are respectively turned on by turns. In addition, the turning on/off time points of each of the output light-valves 270 and one of the receiving light-valves 280 corresponding thereto are substantially identical. As shown in FIG. 2A and FIG. 2B, when each of the output light-valves 270 and one of the receiving light-valves 280 corresponding thereto are turned simultaneously, the invisible light L2 provided by the backlight 210 passes through the output light-valves 270, the invisible light L2 passing through is reflected by the first reflector 230 as well as the second reflector 240 in sequence so as to be captured by the corresponding photo-sensors 250.

More specifically, by controlling the output light-valves 270, the optical touch-sensing LCD panel 200 can selectively allow the invisible light L2 emitted from the backlight 210 passing through one of the output light-valves 270. When the turning on/off time points of each of the output light-valves 270 and one of the receiving light-valves 280 corresponding thereto are substantially identical, the invisible light L2 merely passes through one output light-valve 270 and one receiving light-valve 280 which are simultaneously turned on. At the same time, the invisible light L2 can be captured by one of the photo-sensors 250 disposed under one of the receiving light-valves 280 that is turned on. At the time point shown in FIG. 2A, the output light-valve 270a and the receiving light-valve 280a are simultaneously turned on for allowing the invisible light L2 passing through, and the output light-valves 270b and the receiving light-valves 280b are simultaneously turned off for blocking the invisible light L2. Accordingly, only one of the photo-sensors 250 disposed under the receiving light-valve 280a can capture the invisible light L2 passing through the output light-valve 270a.

Similarly, at another time point next to the time point shown in FIG. 2A, the output light-valve 270a and the receiving light-valve 280a are simultaneously turned off, and the output light-valve 270b next to the output light-valve 270a and the receiving light-valves 280b next to the receiving light-valve 280a are simultaneously turned on. Accordingly, only one of the photo-sensors 250 disposed under the receiving light-valve 280b next to the receiving light-valve 280a can capture the invisible light L2 passing through the output light-valve 270b next to the output light-valve 270a.

When the output light-valves 270 and the receiving light-valves 280 are respectively turned on by turns, a plurality of invisible light beams for touch-sensing are sequentially formed. When the optical touch-sensing LCD panel 200 is touched by the fingers, stylus or other objects, the touch position can be accurately estimated by processing the signals generated from the photo-sensors 250. In other words, the touch-sensing definition of the optical touch-sensing LCD panel 200 is relevant to the distribution density of the output light-valves 270 and the receiving light-valves 280. The touch-sensing definition of the optical touch-sensing LCD panel 200 is irrelevant to the quantity of the sensing light sources 214. Here, the touch-sensing definition of the optical touch-sensing LCD panel 200 is defined as the amount of the recognizable touch positions on the optical touch-sensing LCD panel 200. In addition, the touch-sensing sensitivity of the optical touch-sensing LCD panel 200 not only is relevant to the distribution density of the output light-valves 270 and the receiving light-valves 280, but also is relevant to the refresh (turning-on) frequency of the output light-valves 270 and the receiving light-valves 280.

In the present embodiment, the backlight 210 includes a light guide plate 212 and a sensing light sources 214 for providing the invisible light L2, wherein the sensing light sources 214 may be at least one IR-LED for the IR light (L2), for example. In the optical touch-sensing LCD panel 200 of the present embodiment, in order to ensure that the invisible light L2 with sufficient intensity can be captured by the photo-sensors 250, one ordinary skilled in the art can properly modify dimensions of the output light-valves 270 and the receiving light-valves 280. For instance, the dimensions of the output light-valves 270 and the receiving light-valves 280 are several times the size of the pixels in the pixel array 260 so as to provide invisible light L2 with sufficient intensity. Accordingly, the touch-sensing definition of the optical touch-sensing LCD panel 200 is irrelevant to the quantity of the sensing light sources 214. The touch-sensing definition of the optical touch-sensing LCD panel 200 is relevant to the quantity of the output light-valve 270 and the receiving light-valve 280. Hence, in the present embodiment, the quantity of the sensing light sources 214 can be less than the quantity of the photo-sensors 250.

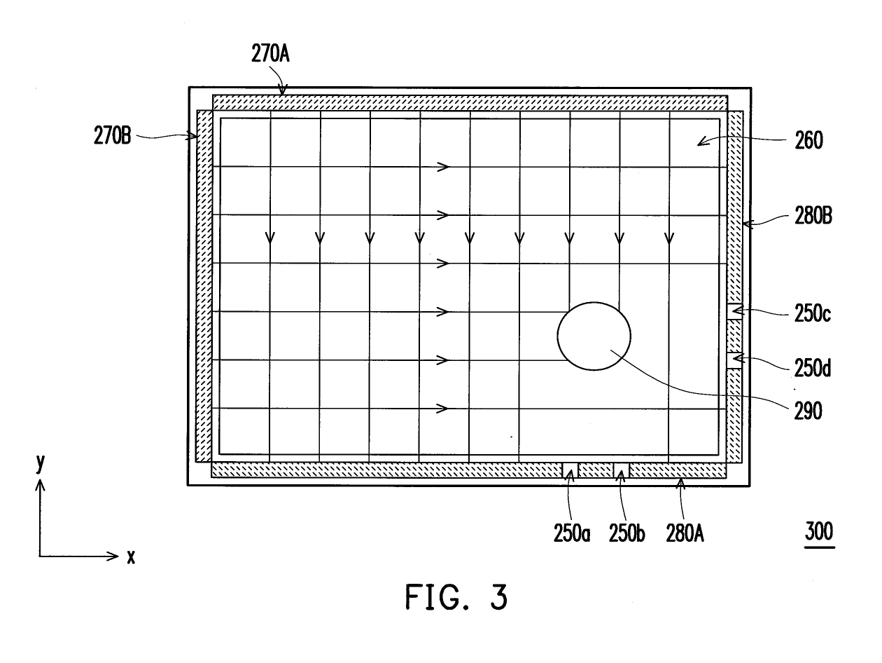

FIG. 3 schematically illustrates a top view of another optical touch-sensing LCD panel in accordance with the first embodiment of the present invention. Referring to FIG. 3, in the optical touch-sensing LCD panel 300, the output light-valves 270 includes a plurality of first output light-valves 270A arranged along a column direction X and a plurality of second output light-valves 270B arranged along a row direction Y, while the receiving light-valves 280 includes a plurality of first receiving light-valves 280A arranged along the column direction X and a plurality of second receiving light-valves 280B arranged along the row direction Y. In other words, the first output light-valves 270A and the second output light-valves 270B are arranged along the long sides of the optical touch-sensing LCD panel 300, while the first receiving light-valves 280A and the second receiving light-valves 280B are arranged along the short sides of the optical touch-sensing LCD panel 300.

The operation of the first output light-valves 270A, the second output light-valves 270B, the first receiving light-valves 280A and the second receiving light-valves 280B is similar with that of the output light-valves 270 and the receiving light-valves 280 mentioned in the previous embodiment. Specifically, the first output light-valves 270A the first receiving light-valves 280A are turned on by turns, and the turning on/off time points of each of the first output light-valves 270A and one of the first receiving light-valves 280A corresponding thereto are substantially identical. Accordingly, only one of the photo-sensors 250 disposed under one of the first receiving light-valves 280A can capture the invisible light L2 passing through one of the first output light-valves 270A. The second output light-valves 270B the second receiving light-valves 280B are turned on by turns, and the turning on/off time points of each of the second output light-valves 270B and one of the second receiving light-valves 280B corresponding thereto are substantially identical. Accordingly, only one of the photo-sensors 250 disposed under one of the second receiving light-valves 280B can capture the invisible light L2 passing through one of the second output light-valves 270B. As shown in FIG. 3, when an object 290 touches the optical touch-sensing LCD panel 300, a part of the invisible light L2 is shielded by the object 290 such that the part of the invisible light L2 shielded by the object 290 can not be transmitted to the photo-sensors 250a, 250b disposed under the first receiving light-valves 280A and the photo-sensors 250c, 250d disposed under the second receiving light-valves 280B. Accordingly, the touch position is determined by the signal generated by the photo-sensors 250a, 250b, 250c and 250d.

In the present invention, the touch-sensing definition of the optical touch-sensing LCD panel 300 is relevant to the distribution density of the output light-valves 270 and the receiving light-valves 280. The touch-sensing definition of the optical touch-sensing LCD panel 300 is irrelevant to the quantity of the sensing light sources. Here, the touch-sensing definition of the optical touch-sensing LCD panel 300 is defined as the amount of the recognizable touch positions on the optical touch-sensing LCD panel 300. For example, the touch-sensing definition of the optical touch-sensing LCD panel 300 is equal to the product of the quantity of the output light-valves 270 and the quantity of the receiving light-valves 280. Accordingly, the optical touch-sensing LCD panel 300 of the present invention can reduce fabrication costs and the quantity of the sensing light sources without lowering touch-sensing definition thereof.

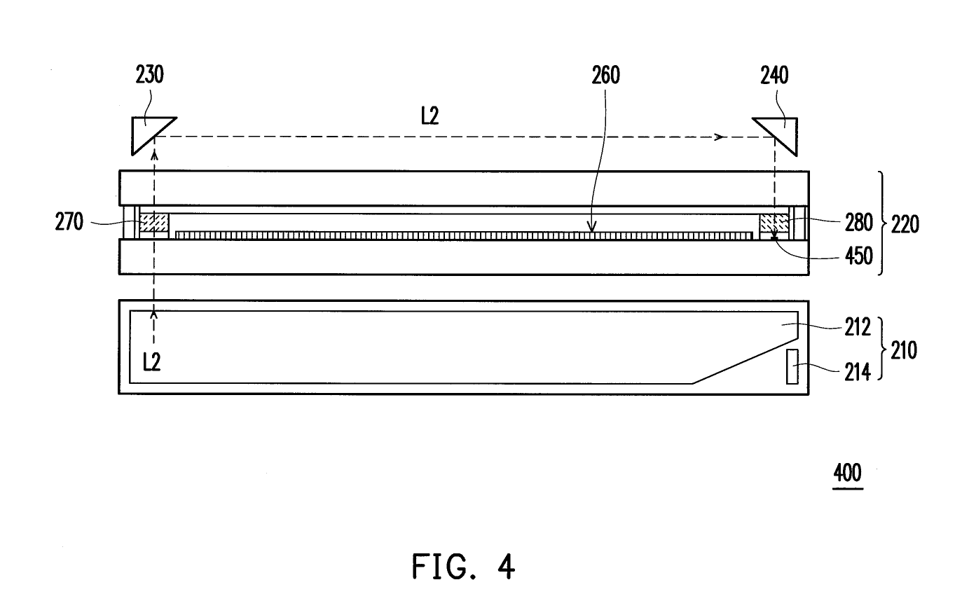

FIG. 4 schematically illustrates a top view of another optical touch-sensing LCD panel in accordance with the first embodiment of the present invention. Referring to FIG. 4, the optical touch-sensing LCD panel 400 is similar with the optical touch-sensing LCD panels 200 and 300 except that the photo-sensors 450 is integrated in the optical touch-sensing LCD panel 400. Same components therein are represented by the same reference numbers or symbols. In other words, the photo-sensors 450 is an in-cell IR sensor, for example.

### Second Embodiment

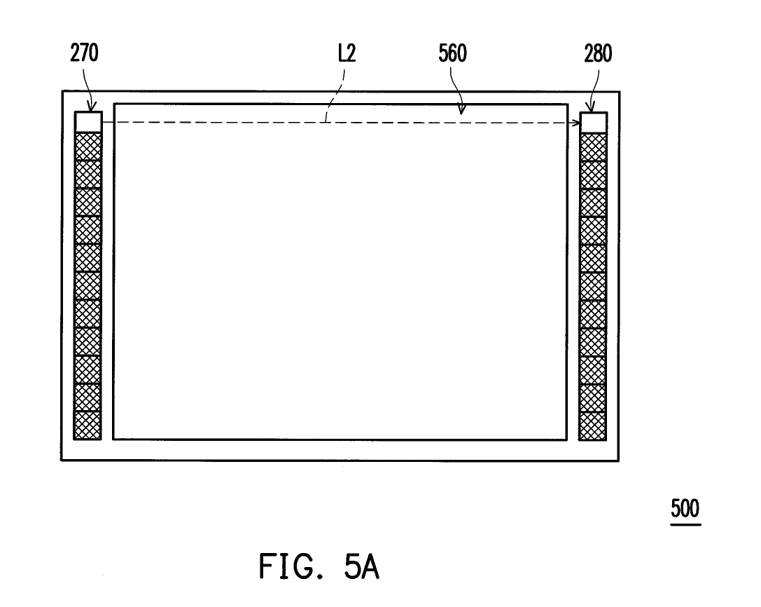

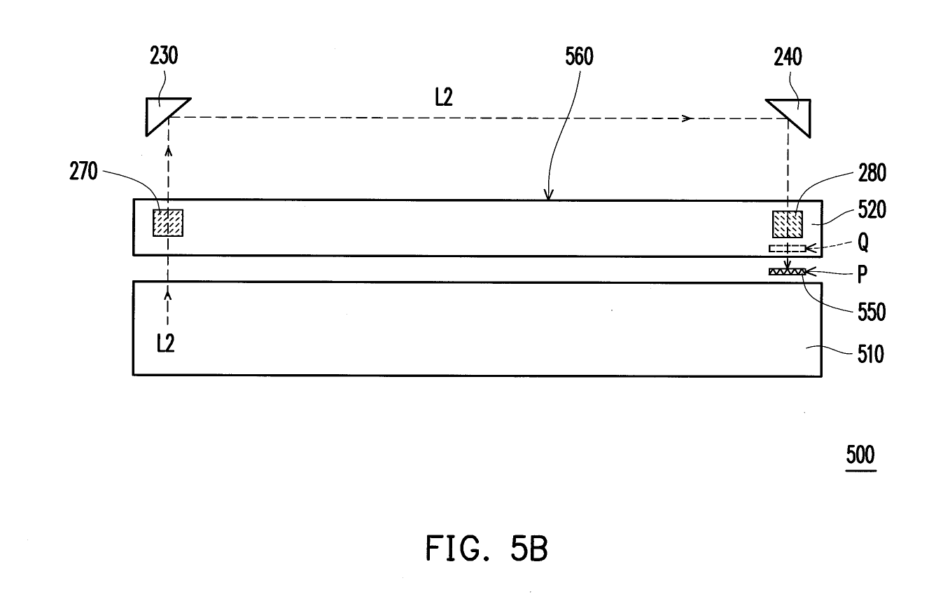

FIG. 5A and FIG. 5B are schematic views of an optical touch-sensing LCD panel in accordance with the second embodiment of the present invention, wherein FIG. 5A and FIG. 5B respectively illustrate a top view and a cross-sectional view of the optical touch-sensing LCD panel. The optical touch-sensing panel of the present embodiment is similar with the optical touch-sensing LCD panel of the first embodiment except that the optical touch-sensing panel of the present embodiment is not required to have display function.

Referring to FIG. 5A and FIG. 5B, the optical touch-sensing panel 500 includes a light source 510, a touch panel 520, a first reflector 230, a second reflector 240 and a plurality of photo-sensors 550. The touch panel 520 includes a touch-sensing region 560, a plurality of output light-valves 270 located outside the touch-sensing region 560. In addition to the output light-valves 270, the touch panel 520 further includes a plurality of receiving light-valves 280 located outside the touch-sensing region 560, the output light-valves 270 and the receiving light-valves 280 are disposed at opposite sides of the touch-sensing region 560 respectively. In order to clearly describe the output light-valves 270 and the receiving light-valves 280, the illustrations of the first reflector 230 and the second reflector 240 are omitted in FIG. 5A.

In the optical touch-sensing panel 500 of the present embodiment as shown in FIG. 5A and FIG. 5B, the light source 510 is disposed under the output light-valves 270 and provides the invisible light L2. In order to ensure that the invisible light L2 with sufficient intensity can be captured by the photo-sensors 250, one ordinary skilled in the art can properly modify dimensions of the output light-valves 270 and the receiving light-valves 280. Moreover, the first reflector 230 is disposed above the output light-valves 270, while the second reflector 240 is disposed above the receiving light-valves 280, as shown in FIG. 5B. Each of the photo-sensors 550 is disposed under one of the receiving light-valves 280. Specifically, the photo-sensors 550 may be disposed under the touch panel 520 and (the position “P” shown in FIG. 5B) or be integrated in the touch panel 520 (the position “Q” shown in FIG. 5B).

Referring to FIG. 5A and FIG. 5B, the operation and the installation of the output light-valves 270 and the receiving light-valves 280 are similar with those of the first embodiment. In detail, the output light-valves 270 and the receiving light-valves 280 are respectively turned on by turns. Each of the output light-valves 270 and one of the receiving light-valves 280 corresponding thereto are turned on and turned off simultaneously. When each of the output light-valves 270 and one of the receiving light-valves 280 corresponding thereto are turned on, the invisible light L2 provided by the light source 510 passes through the output light-valves 270, the invisible light L2 passing through the output light-valves 270 is reflected by the first reflector 230 as well as the second reflector 240 in sequence and passes through the receiving light-valves 280, and the invisible light L2 passing through the receiving light-valves 280 is captured by the corresponding photo-sensors 550. When the output light-valves 270 and the receiving light-valves 280 are respectively turned on by turns, a plurality of invisible light beams for touch-sensing are sequentially formed over the touch-sensing region 560. Furthermore, when the optical touch-sensing LCD panel 500 is touched by the fingers, stylus or other objects, the touch position can be accurately estimated by processing the signals generated from the photo-sensors 550. Accordingly, the optical touch-sensing panel 500 of the present invention can reduce fabrication costs and the quantity of the sensing light sources without lowering touch-sensing definition thereof.

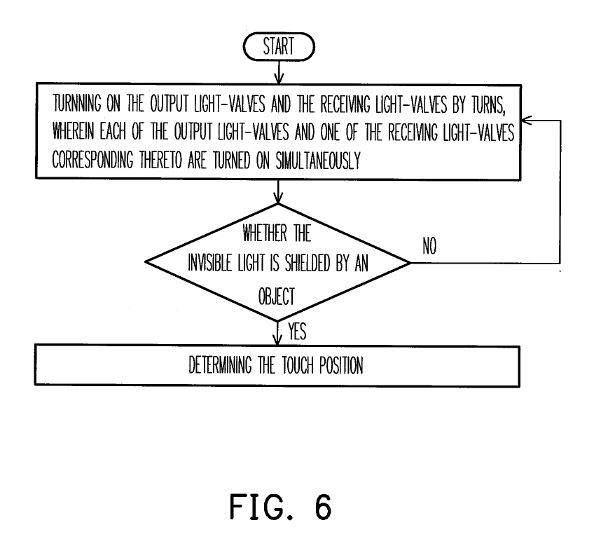

FIG. 6 is a flow chart illustrating a method of determining the touch position according to an embodiment of the present invention. The method of determining the touch position can be applied to the optical touch-sensing panel 500 shown in FIG. 5A and FIG. 5B. Of course, the method of determining the touch position can also be applied to the optical touch-sensing LCD panels 200 and 300. Referring to FIG. 5A, FIG. 5B and FIG. 6, the method of determining the touch position according to this embodiment includes the following steps. First, the output light-valves 270 and the receiving light-valves 280 are respectively turned on by turns, wherein each of the output light-valves 270 and one of the receiving light-valves 280 corresponding thereto are turned on and turned off simultaneously, when each of the output light-valves 270 and one of the receiving light-valves 280 corresponding thereto are turned on, the invisible light L2 provided by the light source 510 passes through the output light-valves 270, the invisible light L2 passing through the output light-valves 270 is reflected by the first reflector 230 as well as the second reflector 240 in sequence and passes through the receiving light-valves 280, and the invisible light L2 passing through the receiving light-valves 280 is captured by the corresponding photo-sensors 550. In other words, when an object touches the optical touch-sensing panel 500, a part of the invisible light L2 passing through the output light-valves 270 and being reflected by the first reflector 230 is shielded by the object 290 such that the part of the invisible light L2 shielded by the object 290 can not be transmitted to the corresponding photo-sensors 550. Accordingly, the touch position is determined by the photo-sensors 550. Therefore, in the above-mentioned method of determining the touch position, the optical touch-sensing LCD panel and the optical touch-sensing panel, the photo-sensors and the sensing light sources (or light source) are not required to be adopted one-on-one. In other words, the quantity of the sensing light sources (or light source) can be less than the quantity of the photo-sensors.

In the optical touch-sensing LCD panel and the optical touch-sensing panel of the present invention, the touch position can be determined by control of the output light-valves and the receiving light-valves, the touch-sensing definition thereof is not limited by the quantity of the sensing light source. Accordingly, the present invention can reduce fabrication costs and the quantity of the sensing light sources used without lowering touch-sensing definition.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An optical touch-sensing liquid crystal display (LCD) panel, comprising:
a backlight capable of providing a visible light and an invisible light;
a LCD panel disposed above the backlight, the LCD panel including a pixel array and a plurality of output light-valves located outside the pixel array;
a first reflector disposed above the output light-valves;
a second reflector; and
a plurality of photo-sensors disposed under the second reflector, wherein the output light-valves and the photo-sensors are respectively turned on by turns, when each of the output light-valves is turned on, the invisible light provided by the backlight passes through the output light-valves, the invisible light passing through is reflected by the first reflector as well as the second reflector in sequence so as to be captured by the corresponding photo-sensors.

2. The optical touch-sensing LCD panel of claim 1, further comprising a plurality of receiving light-valves located outside the pixel array, the output light-valves and the receiving light-valves being disposed at opposite sides of the pixel array respectively, the second reflector being disposed above the receiving light-valves, and each of the photo-sensors being disposed under one of the receiving light-valves respectively, wherein the output light-valves and the receiving light-valves are respectively turned on by turns; each of the output light-valves and one of the receiving light-valves corresponding thereto are turned on and turned off simultaneously; when each of the output light-valves and one of the receiving light-valves corresponding thereto are turned on, the invisible light provided by the backlight passes through the light-valve for outputting light, the invisible light passing through is reflected by the first reflector as well as the second reflector in sequence and passes through the light-valve for inputting light, and the invisible light passing through the light-valve for inputting light is captured by the corresponding photo-sensors.

3. The optical touch-sensing LCD panel of claim 2, wherein the output light-valves includes a plurality of first output light-valves arranged along a column direction and a plurality of second output light-valves arranged along a row direction, while the receiving light-valves includes a plurality of first receiving light-valves arranged along the column direction and a plurality of second receiving light-valves arranged along the row direction.

4. The optical touch-sensing LCD panel of claim 3, wherein the output light-valves and the first receiving light-valves are respectively turned on by turns, each of the output light-valves and one of the first receiving light-valves corresponding thereto are turned on and turned off simultaneously, the second output light-valves and the receiving light-valves are respectively turned on by turns, and each of the second output light-valves and one of the receiving light-valves corresponding thereto are turned on and turned off simultaneously.

5. The optical touch-sensing LCD panel of claim 1, wherein the photo-sensors are disposed under the LCD panel.

6. The optical touch-sensing LCD panel of claim 1, wherein the photo-sensors are integrated in the LCD panel.

7. The optical touch-sensing LCD panel of claim 1, wherein the visible light is white light and the invisible light is infrared light.

8. A optical touch-sensing panel, comprising:
a touch panel, comprising a touch-sensing region and a plurality of output light-valves located outside the touch-sensing region;
a light source, disposed under the output light-valves and providing an invisible light;
a first reflector disposed above the output light-valves;
a second reflector; and
a plurality of photo-sensors disposed under the second reflector, wherein the output light-valves and the photo-sensors are respectively turned on by turns, when each of the output light-valves is turned on, the invisible light provided by the backlight passes through the output light-valves, the invisible light passing through is reflected by the first reflector as well as the second reflector in sequence so as to be captured by the corresponding photo-sensors.

9. The optical touch-sensing panel of claim 8, further comprising a plurality of receiving light-valves located outside the touch-sensing region, the output light-valves and the receiving light-valves being disposed at opposite sides of the touch-sensing region respectively, the second reflector being disposed above the receiving light-valves, and each of the photo-sensors being disposed under one of the receiving light-valves respectively, wherein the output light-valves and the receiving light-valves are respectively turned on by turns; each of the output light-valves and one of the receiving light-valves corresponding thereto are turned on and turned off simultaneously; when each of the output light-valves and one of the receiving light-valves corresponding thereto are turned on, the invisible light provided by the backlight passes through the light-valve for outputting light, the invisible light passing through is reflected by the first reflector as well as the second reflector in sequence and passes through the light-valve for inputting light, and the invisible light passing through the light-valve for inputting light is captured by the corresponding photo-sensors.

10. The optical touch-sensing panel of claim 9, wherein the output light-valves includes a plurality of first output light-valves arranged along a column direction and a plurality of second output light-valves arranged along a row direction, while the receiving light-valves includes a plurality of first receiving light-valves arranged along the column direction and a plurality of second receiving light-valves arranged along the row direction.

11. The optical touch-sensing panel of claim 10, wherein the output light-valves and the first receiving light-valves are respectively turned on by turns, each of the output light-valves and one of the first receiving light-valves corresponding thereto are turned on and turned off simultaneously, the second output light-valves and the receiving light-valves are respectively turned on by turns, and each of the second output light-valves and one of the receiving light-valves corresponding thereto are turned on and turned off simultaneously.

12. The optical touch-sensing panel of claim 8, wherein the photo-sensors are disposed under the touch panel.

13. The optical touch-sensing panel of claim 8, wherein the photo-sensors are integrated in the touch panel.

14. The optical touch-sensing panel of claim 8, wherein the invisible light is infrared light.

15. A method of determining a touch position, comprising:
providing a optical touch-sensing panel, the optical touch-sensing panel comprising:
a touch panel comprising a touch-sensing region, a plurality of output light-valves located outside the touch-sensing region and a plurality of receiving light-valves located outside the touch-sensing region, the output light-valves and the receiving light-valves being disposed at opposite sides of the touch-sensing region respectively;
a light source disposed under the output light-valves and providing an invisible light;
a first reflector disposed above the output light-valves;
a second reflector disposed above the receiving light-valves;
a plurality of photo-sensors disposed under one of the receiving light-valves; and
turning on the output light-valves and the receiving light-valves respectively by turns, wherein each of the output light-valves and one of the receiving light-valves corresponding thereto are turned on and turned off simultaneously, when each of the output light-valves and one of the receiving light-valves corresponding thereto are turned on, the invisible light provided by the backlight passes through the output light-valves, the invisible light passing through the output light-valves is reflected by the first reflector as well as the second reflector in sequence and passes through the receiving light-valves, and the invisible light passing through the receiving light-valves is captured by the corresponding photo-sensors.
